(19) United States
(12) Patent Application Publication
(10) Pub. No.: US 2018/0340689 A1
(43) Pub. Date: Nov. 29, 2018

(54) Low Profile Axially Staged Fuel Injector

(71) Applicant: General Electric Company, Schenectady, NY (US)

(72) Inventors: Kevin Woodlock, Simpsonville, SC (US); John Keenon, Simpsonville, SC (US)

(21) Appl. No.: 15/604,780

(22) Filed: May 25, 2017

(51) Int. Cl. F23R 3/34; F23R 3/00; F02C 3/04; F02C 7/228

(52) U.S. Cl. CPC F23R 3/346; F02C 7/228; F02C 3/04; F23R 3/002

(57) ABSTRACT

An annularly shaped liner at least partially defines a hot gas path of a combustor. The combustor includes a first combustion zone and a second combustion zone downstream of the first combustion zone. A plurality of fuel injectors in fluid communication with the second combustion zone are integrally formed in the liner and arranged around the liner along the circumferential direction.

### FIELD

The subject matter disclosed herein relates to a combustor for a gas turbine. More specifically, the disclosure is directed to an axially staged fuel injector assembly of a gas turbine combustor.

### BACKGROUND

Gas turbines usually burn hydrocarbon fuels and produce air polluting emissions such as oxides of nitrogen (NOx) and carbon monoxide (CO). Oxidization of molecular nitrogen in the gas turbine depends upon the temperature of gas located in a combustor, as well as the residence time for reactants located in the highest temperature regions within the combustor. Thus, the amount of NOx produced by the gas turbine may be reduced by either maintaining the combustor temperature below a temperature at which NOx is produced, or by limiting the residence time of the reactant in the combustor.

One approach for controlling the temperature of the combustor involves pre-mixing fuel and air to create a lean fuel-air mixture prior to combustion. This approach may include the axial staging of fuel injection where a first fuel-air mixture is injected and ignited at a first or primary combustion zone of the combustor to produce a main flow of high energy combustion gases, and where a second fuel-air mixture is injected into and mixed with the main flow of high energy combustion gases via a plurality of radially oriented and circumferentially spaced fuel injectors or axially staged fuel injector assemblies positioned downstream from the primary combustion zone. Axially staged injection increases the likelihood of complete combustion of available fuel, which in turn reduces the air polluting emissions.

During operation of the combustor, it is necessary to cool one or more liners or ducts that form a combustion chamber and/or a hot gas path through the combustor. Liner cooling is typically achieved by routing a cooling medium such as the compressed air through a cooling flow annulus or flow passage defined between the liner and a flow sleeve and/or an impingement sleeve that surrounds the liner. However, in particular configurations, hardware for mounting the axially staged fuel injector assemblies creates a flow blockage or obstruction within the cooling flow annulus, thereby disrupting the cooling flow through the cooling flow annulus. This disruption in the cooling flow annulus may result in reduced pressure of the cooling medium at a head end portion of the combustor and/or reduced cooling effectiveness of the cooling medium within the cooling flow annulus, particularly downstream from the mounting hardware.

### BRIEF DESCRIPTION

Aspects and advantages are set forth below in the following description, or may be obvious from the description, or may be learned through practice.

One embodiment is a combustor for a turbomachine. The combustor includes a central axis. The central axis of the combustor defines an axial direction, a radial direction perpendicular to the central axis, and a circumferential direction extending around the central axis. The combustor also includes an annularly shaped liner at least partially defining a hot gas path with a flow sleeve circumferentially surrounding at least a portion of the liner. The flow sleeve is spaced from the liner along the radial direction to form a cooling flow annulus therebetween. The combustor also includes a first combustion zone at least partially defined by the liner and a second combustion zone at least partially defined by the liner downstream of the first combustion zone. A plurality of fuel injectors are in fluid communication with the second combustion zone. The plurality of fuel injectors are integrally formed in the liner and arranged around the liner along the circumferential direction.

Another embodiment of the present disclosure is a gas turbine. The gas turbine includes a compressor, a turbine downstream from the compressor, and a combustor disposed downstream from the compressor and upstream from the turbine. The combustor includes a central axis. The central axis of the combustor defines an axial direction, a radial direction perpendicular to the central axis, and a circumferential direction extending around the central axis. The combustor also includes an annularly shaped liner at least partially defining a hot gas path with a flow sleeve circumferentially surrounding at least a portion of the liner. The flow sleeve is spaced from the liner along the radial direction to form a cooling flow annulus therebetween. The combustor also includes a first combustion zone at least partially defined by the liner and a second combustion zone at least partially defined by the liner downstream of the first combustion zone. A plurality of fuel injectors are in fluid communication with the second combustion zone. The plurality of fuel injectors are integrally formed in the liner and arranged around the liner along the circumferential direction.

Those of ordinary skill in the art will better appreciate the features and aspects of such embodiments, and others, upon review of the specification.

### BRIEF DESCRIPTION OF THE DRAWINGS

A full and enabling disclosure of the of various embodiments, including the best mode thereof to one skilled in the art, is set forth more particularly in the remainder of the specification, including reference to the accompanying figures, in which:

FIG. 1 is a functional block diagram of an exemplary gas turbine that may incorporate various embodiments of the present disclosure;

FIG. 2 is a simplified side section view of an exemplary combustor as may incorporate various embodiments of the present disclosure;

FIG. 3 provides a transverse section view of a portion of the combustor including axially staged fuel injectors according to at least one embodiment of the present disclosure;

FIG. 4 provides a transverse section view of a portion of the combustor including a plurality of fuel plenums according to at least one embodiment of the present disclosure;

FIG. 5 is a side section view of a portion of the combustor as shown in FIGS. 3 and 4 taken along line 5-5, according to at least one embodiment of the present disclosure;

FIG. 6 is a side section view of a portion of the combustor as shown in FIGS. 3 and 4 taken along line 6-6, according to at least one embodiment of the present disclosure;

FIG. 7 is a side section view of a portion of the combustor as shown in FIGS. 3 and 4 taken along line 7-7, according to at least one embodiment of the present disclosure;

FIG. 8 is a side section view of a portion of the combustor as shown in FIGS. 3 and 4 taken along line 8-8, according to at least one embodiment of the present disclosure;

FIG. 9 is a side section view of a portion of the combustor as shown in FIGS. 3 and 4 taken along line 9-9, according to at least one embodiment of the present disclosure; and

FIG. 10 provides an enlarged view of a portion of FIG. 3.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation, not limitation. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents. Although exemplary embodiments of the present disclosure will be described generally in the context of a combustor for a land based power generating gas turbine combustor for purposes of illustration, one of ordinary skill in the art will readily appreciate that embodiments of the present disclosure may be applied to any style or type of combustor for a turbomachine and are not limited to combustors or combustion systems for land based power generating gas turbines unless specifically recited in the claims.

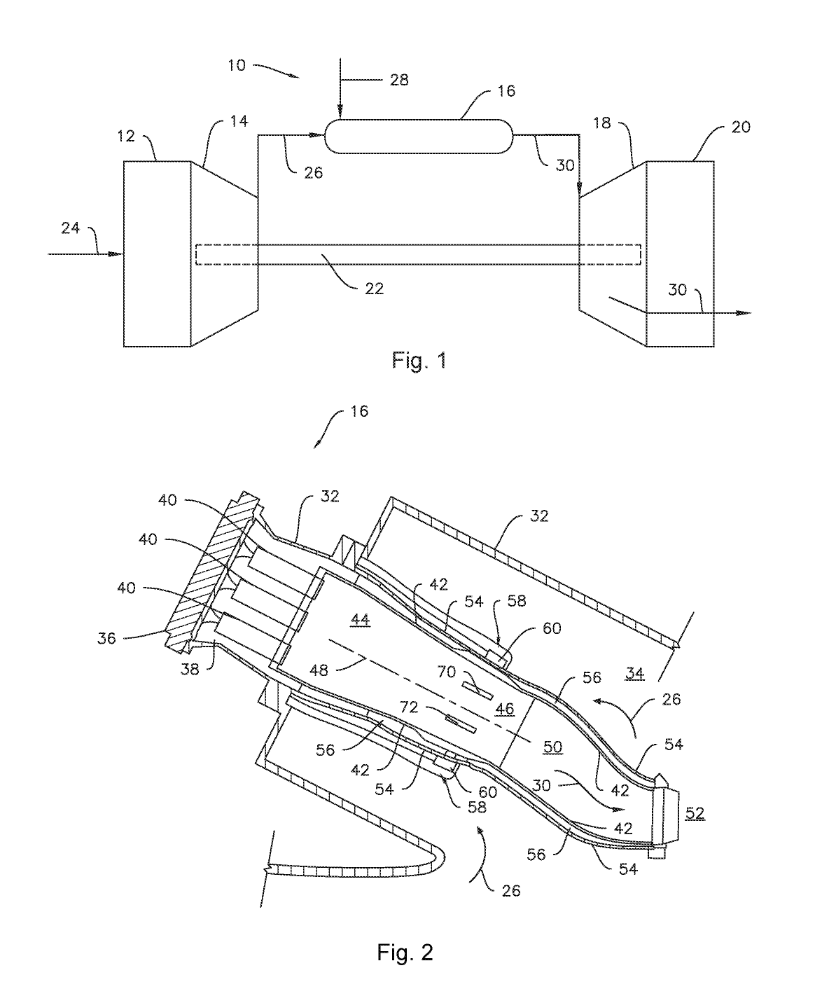

Referring now to the drawings, FIG. 1 illustrates a schematic diagram of an exemplary gas turbine 10. The gas turbine 10 generally includes an inlet section 12, a compressor 14 disposed downstream of the inlet section 12, at least one combustor 16 disposed downstream of the compressor 14, a turbine 18 disposed downstream of the combustor 16 and an exhaust section 20 disposed downstream of the turbine 18. Additionally, the gas turbine 10 may include one or more shafts 22 that couple the compressor 14 to the turbine 18.

During operation, air 24 flows through the inlet section 12 and into the compressor 14 where the air 24 is progressively compressed, thus providing compressed air 26 to the combustor 16. At least a portion of the compressed air 26 is mixed with a fuel 28 within the combustor 16 and burned to produce combustion gases 30. The combustion gases 30 flow from the combustor 16 into the turbine 18, wherein energy (kinetic and/or thermal) is transferred from the combustion gases 30 to rotor blades (not shown), thus causing shaft 22 to rotate. The mechanical rotational energy may then be used for various purposes such as to power the compressor 14 and/or to generate electricity. The combustion gases 30 exiting the turbine 18 may then be exhausted from the gas turbine 10 via the exhaust section 20.

As shown in FIG. 2, the combustor 16 may be at least partially surrounded by an outer casing 32 such as a compressor discharge casing. The outer casing 32 may at least partially define a high pressure plenum 34 that at least partially surrounds various components of the combustor 16. The high pressure plenum 34 may be in fluid communication with the compressor 14 (FIG. 1) so as to receive the compressed air 26 from the compressor 14. An end cover 36 may be coupled to the outer casing 32. In particular embodiments, the outer casing 32 and the end cover 36 may at least partially define a head end volume or portion 38 of the combustor 16. In particular embodiments, the head end portion 38 is in fluid communication with the high pressure plenum 34 and/or the compressor 14.

Fuel nozzles 40 extend axially downstream from the end cover 36. One or more annularly shaped liners or ducts 42 may at least partially define a primary or first combustion or reaction zone 44 for combusting the first fuel-air mixture and/or may at least partially define a secondary combustion or reaction zone 46 formed axially downstream from the first combustion zone 44 with respect to an axial centerline 48 of the combustor 16. The liner 42 at least partially defines a hot gas path 50 from the primary fuel nozzle(s) 40 to an inlet 52 of the turbine 18 (FIG. 1). In at least one embodiment, the liner 42 may be formed so as to include a tapering or transition portion. In particular embodiments, the liner 42 may be formed from a singular or continuous body, sometimes also referred to as a unibody. Other embodiments may include a separate combustion liner and transition piece. A flow sleeve 54 circumferentially surrounds at least a portion of the liner 42. The flow sleeve 54 is radially spaced from the liner 42 to form a cooling flow annulus 56 therebetween.

In at least one embodiment, the combustor 16 includes an axially staged fuel injection system 58. At least portions of the axially staged fuel injection system 58 may be integrally formed with the liner 42. The axially staged fuel injection system 58 includes at least one fuel supply 60 axially staged or spaced from the primary fuel nozzle(s) 40 with respect to axial centerline 48. The fuel supply 60 is disposed downstream of the primary fuel nozzle(s) 40 and upstream of the inlet 52 to the turbine 18. It is contemplated that a number of fuel supplies 60 (including two, three, four, five, or more fuel supplies 60) may be used in a single combustor 16.

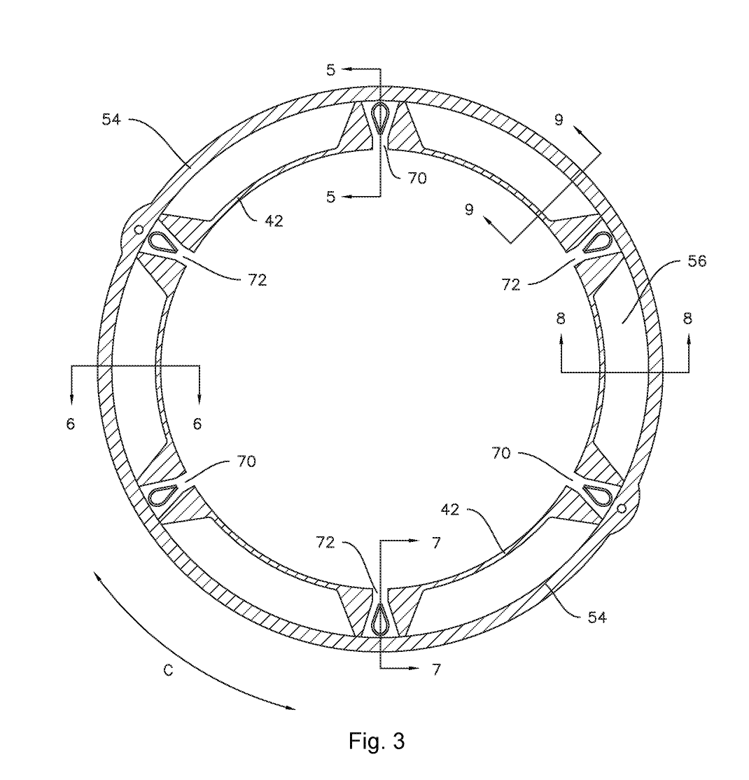

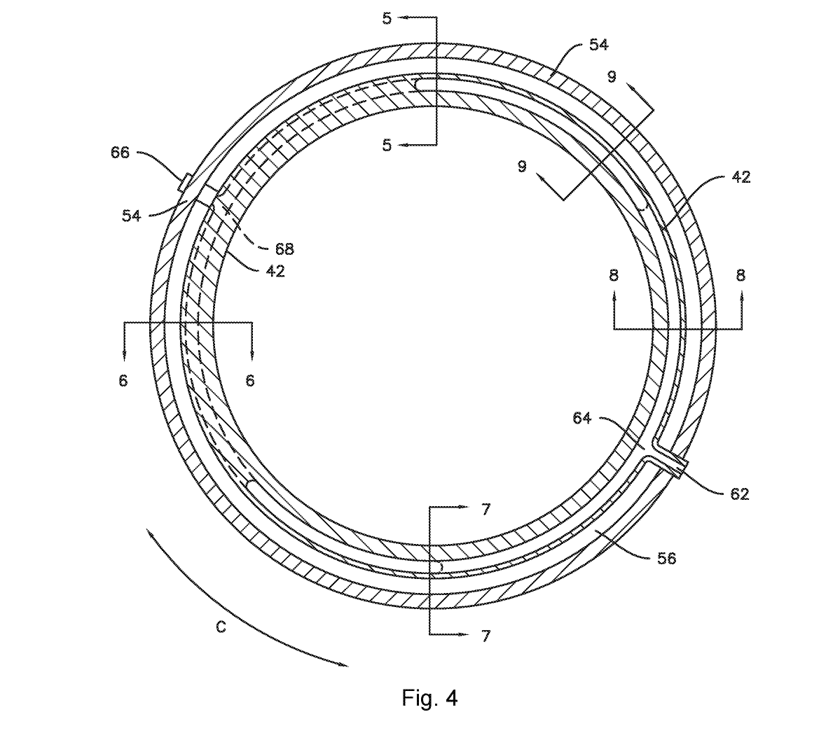

In at least one embodiment, as shown in FIGS. 3 and 4 collectively, the liner 42 may be annularly shaped and may define a circumferential direction C extending around the combustor 16 (FIG. 2), e.g., around the axial centerline 48 (FIG. 2) thereof. The flow sleeve 54 circumferentially surrounds at least a portion of the liner 42 and the cooling flow annulus 56 is formed radially therebetween. As shown in FIG. 4, one or more fuel ports may extend radially from the liner 42 through the flow sleeve 54, e.g., in the example embodiment illustrated in FIG. 4, a first fuel port 62 and a second fuel port 66 are provided. The first fuel port 62 and the second fuel port 66 may be integrally formed with the liner 42, as illustrated in FIG. 4. The first fuel port 62 and second fuel port 66 may each be configured to mate with a respective one of the fuel supplies 60 to form a fluid connection therebetween.

The axially staged fuel injection system 58 may include a plurality of circuits, for example, as illustrated in FIGS. 3 and 4, the axially staged fuel injection system 58 may include two circuits. For example, as illustrated in FIG. 3, a first plurality of fuel injectors 70 and a second plurality of fuel injectors 72 may be arranged circumferentially around the liner 42 in the secondary combustion zone 46. In such embodiments the first plurality of fuel injectors 70 and the second plurality of fuel injectors 72 may alternate around the circumference of the liner 42, e.g., as illustrated in FIG. 3. Further, the first plurality of fuel injectors 70 and the second plurality of fuel injectors 72 may be integrally formed with the liner 42. As illustrated in FIG. 4, the first fuel port 62 may be in fluid communication with a first fuel plenum 64 defined within the liner 42 and the second fuel port 66 may be in fluid communication with a second fuel plenum 68 defined within the liner 42. Accordingly, the axially staged fuel injection system 58 may include a first circuit including the first fuel port 62, first fuel plenum 64, and first plurality of fuel injectors 70, and a second circuit including the second fuel port 66, second fuel plenum 68, and second plurality of fuel injectors 72. In such embodiments, each circuit may advantageously be connected to an independent fuel supply 60 such that the first circuit and second circuit may be operated independently of each other. For example, such flexibility of operation may be advantageous during part-load and/or turn down operations.

As noted above, portions of the axially staged fuel injection system 58 may be integrally formed with the liner 42. It is to be understood that integrally formed includes any suitable method of forming the respective parts such that they comprise a single unitary and seamless whole. For example, each of the liner 42, the first fuel port 62, first fuel plenum 64, first plurality of fuel injectors 70, the second fuel port 66, second fuel plenum 68, and second plurality of fuel injectors 72 may be integrally formed in a one-piece seamless construction. Suitable methods of integrally forming the relevant parts include additive manufacturing, such as direct metal laser melting, selective laser sintering, or other suitable additive techniques. As another example, the liner 42, the first fuel port 62, first fuel plenum 64, first plurality of fuel injectors 70, the second fuel port 66, second fuel plenum 68, and second plurality of fuel injectors 72 may be integrally formed by casting the parts as a single piece.

Still with reference to FIGS. 3 and 4, each of the first and second fuel plenums 64 and 68 may extend at least partially along the circumference of the liner 42. For example, the first fuel plenum 64 may extend only so far around the circumference of the liner 42 as necessary to provide fluid communication between the first fuel port 62 and each fuel injector of the first plurality of fuel injectors 70, and the second fuel plenum 68 may extend only so far around the circumference of the liner 42 as necessary to provide fluid communication between the second fuel port 66 and each fuel injector of the second plurality of fuel injectors 72.

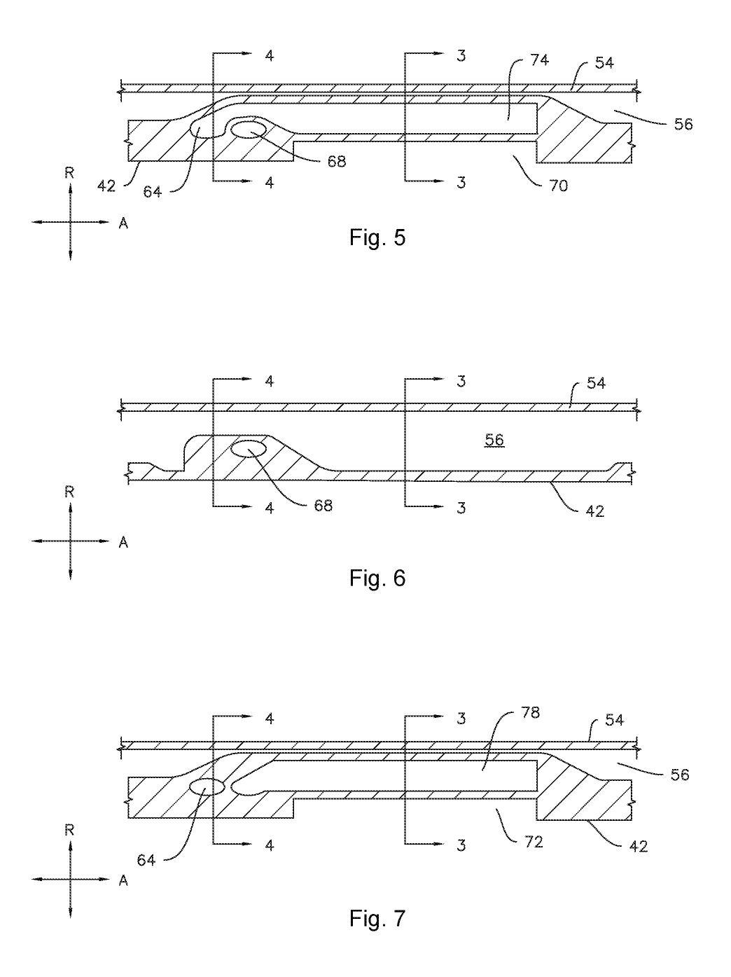

As may be best seen in the longitudinal section views provided in FIGS. 5-9, the combustor 16 (FIG. 2) may define an axial direction A, e.g., along or parallel to the axial centerline 48 (FIG. 2) and a radial direction R perpendicular to the axial direction A. Also as seen in FIGS. 5-9, the first fuel plenum 64 and the second fuel plenum 68 may be aligned along the radial direction R and spaced apart along the axial direction A. Such configuration advantageously provides a low profile axially staged fuel injector system with a relatively small radial dimension, e.g., as compared to the radial dimension of the cooling flow annulus 56, so as to reduce or minimize obstruction of flow within the cooling flow annulus 56.

In some embodiments, for example as illustrated in FIG. 5, the first plurality of fuel injectors 70 may be slot fuel injectors extending generally along the axial direction A. That is, each fuel injector of the first plurality of fuel injectors 70 may define an elongated shape such as a rectangle with the larger dimension oriented generally along the axial direction (see also FIG. 2). It should be understood that the illustrated slot fuel injectors 70 are just one possible example of the form of the fuel injectors 70. In alternate embodiments, the fuel injectors 70 may define any suitable shape, such as but not limited to cylindrical, conical, oval, teardrop and the like. As used herein, terms of approximation such as “about,” “generally, or other similar terms are understood to include within ten percent above or below the stated amount. In the context of an angle or direction, such terms include within ten degrees of the stated angle or direction. As illustrated in FIG. 5, fuel may be supplied to each fuel injector of the first plurality of fuel injectors 70 from the first fuel plenum 64 via a first plurality of axial channels 74 within the liner 42. The first plurality of axial channels 74, e.g., one of which is illustrated in FIG. 5, may extend downstream of the first fuel plenum 64. In such embodiments, and where the second fuel plenum 68 is also downstream of the first fuel plenum 64, each axial channel of the first plurality of axial channels 74 may include an upstream portion which extends outward along the radial direction R (e.g., away from the axial centerline 48) and around the second fuel plenum 68. Integrally forming the liner 42, first fuel plenum 64, second fuel plenum 68, and axial channel 74 may advantageously provide a low profile, e.g., the radial dimension required to permit the upstream portion of each axial channel of the plurality of axial channels 74 to clear the second fuel plenum 68 may be reduced, thus keeping the overall radial dimension to a minimum.

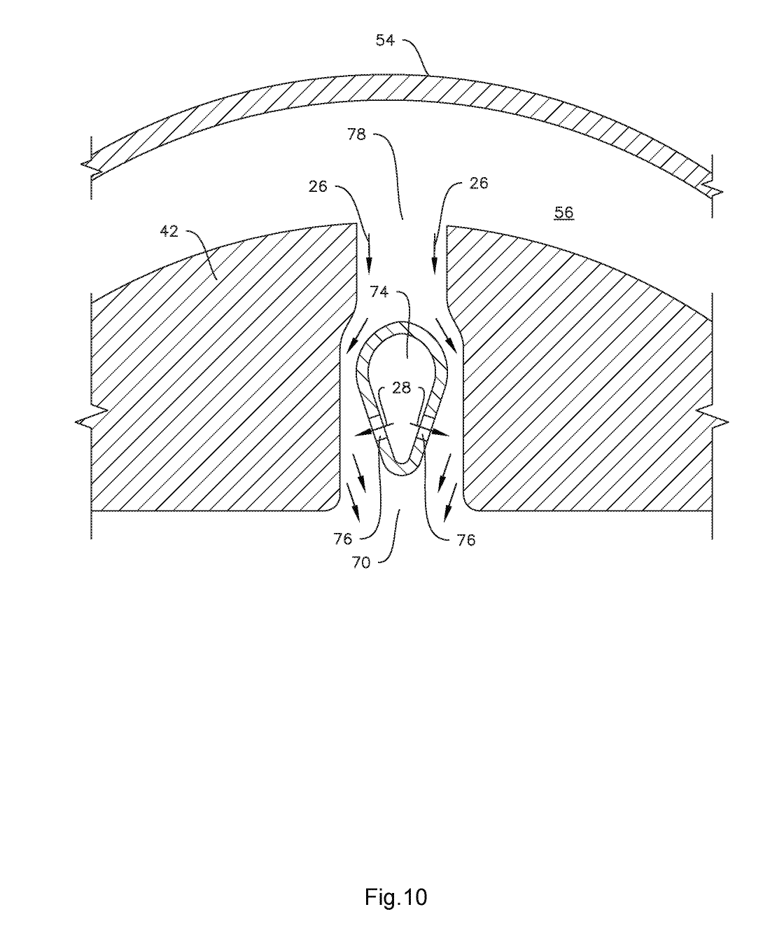

FIG. 6 is a side section view of a portion of the combustor as shown in FIGS. 3 and 4 taken along line 6-6. In particular, FIG. 6 illustrates a portion of the liner 42 beyond the circumferential extent of the first fuel plenum 64, such that in the illustrated portion of the liner 42, only the second fuel plenum 68 is present. Similarly, FIG. 9 is a side section view of a portion of the combustor as shown in FIGS. 3 and 4 taken along line 9-9, such that FIG. 9 illustrates a portion of the liner 42 beyond the circumferential extent of the second fuel plenum 68, such that in the illustrated portion of the liner 42, only the first fuel plenum 64 is present. Providing the first fuel plenum 64 and the second fuel plenum 68 with limited circumferential extents as illustrated in FIG. 4 and described above may advantageously provide increased thermal and structural properties to the liner 42. Further, such configuration may also advantageously provide reduced material requirements for forming the liner 42 and integrated axially staged fuel injection system 58.

FIG. 7 is a side section view taken through one fuel injector of the second plurality of fuel injectors 72. Similarly to the exemplary one fuel injector of the first plurality of fuel injectors 70 illustrated in FIG. 5, the exemplary one fuel injector of the second plurality of fuel injectors 72 in FIG. 7 may be configured as a slot fuel injector or in any other suitable form, as described above. As illustrated in FIG. 7, fuel may be supplied to each fuel injector of the second plurality of fuel injectors 72 from the second fuel plenum 68 via a respective one of a second plurality of axial channels 78 within the liner 42.

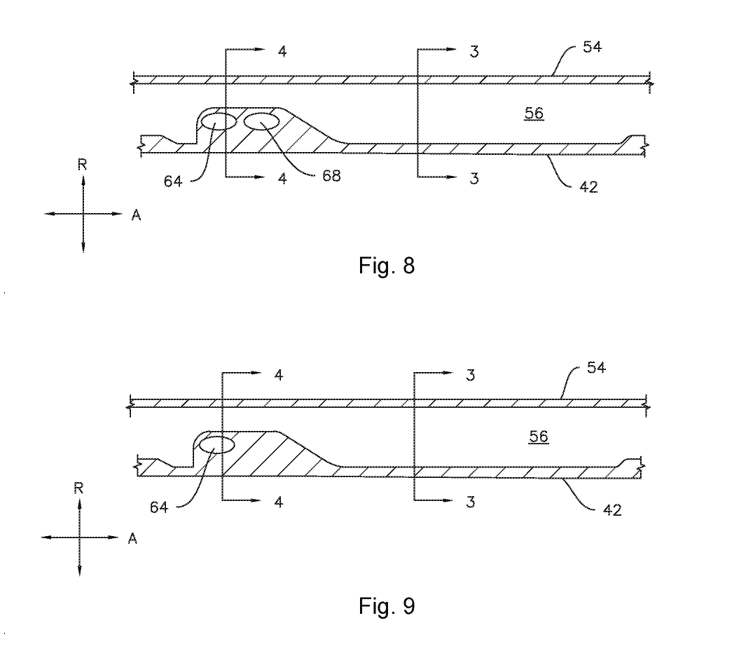

FIG. 8 illustrates a side section view through a portion of the liner 42 where the first fuel plenum 64 and the second fuel plenum 68 circumferentially overlap between adjacent ones of the first plurality of fuel injectors 70 and the second plurality of fuel injectors 72. As may be seen, e.g., in FIG. 8, portions of the axially staged fuel injection system 58 between fuel injectors may have a lower profile, e.g., a reduced radial dimension, which may provide or enhance the advantages described above, e.g., minimized obstruction of cooling flow within the cooling flow annulus 56.

FIG. 10 illustrates a transverse section view through an exemplary one fuel injector of the first plurality of fuel injectors 70, e.g., in an enlarged view of a portion of FIG. 3. As may be seen in FIG. 10, the fuel injector of the first plurality of fuel injectors 70 may provide a pre-mixed blend of air 26 from the cooling flow annulus 56 and fuel 28 from a respective one of the plurality of axial channels 74. As illustrated in FIG. 10, in some embodiments, the air 26 from the cooling flow annulus 56 may enter the exemplary fuel injector 70 via an air inlet 78 and flow radially inward from the air inlet 78 towards the interior of the liner 42, and in particular towards the secondary combustion zone 46 defined therein. Alternatively or in addition, in some example embodiments, the air inlet 78 may be formed in an upstream end of the exemplary fuel injector 70 with respect to the flow direction through the cooling flow annulus 56 such that the air 26 flows from the cooling flow annulus 56 towards the interior of the liner 42 along a direction oblique to both the radial direction R and the axial direction A. In some embodiments, the flow direction through the cooling flow annulus 56 may include flow towards the head end 38 along the axial direction A, e.g., in the opposite direction of the hot gas path, such that the upstream end of the fuel injector with respect to the cooling flow direction may be the downstream end of the fuel injector with respect to the flow of combustion gases. Fuel 28 from the axial channel 74 may flow into the exemplary fuel injector 70 via outlets 76. The outlets 76 may be positioned and oriented to promote mixing of the fuel 28 and the air 26 and to direct the fuel 28 towards the interior of the liner 42, and in particular towards the secondary combustion zone 46 defined therein. The outlets 76 may be cylindrical in cross-section, or may define any suitable shape such as but not limited to conical or frustoconical, elongate, ovoid, and the like. Although not shown, it is to be understood that similar details and configurations as shown in FIG. 10 and described herein with respect to the first plurality of fuel injectors 70 may also be provided in the second plurality of fuel injectors 72.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A combustor for a turbomachine, the combustor comprising a central axis, the central axis of the combustor defines an axial direction, a radial direction perpendicular to the central axis, and a circumferential direction extending around the central axis, the combustor comprising:
an annularly shaped liner at least partially defining a hot gas path;
a flow sleeve circumferentially surrounding at least a portion of the liner, wherein the flow sleeve is spaced from the liner along the radial direction to form a cooling flow annulus therebetween;
a first combustion zone at least partially defined by the liner;
a second combustion zone at least partially defined by the liner downstream of the first combustion zone; and
a plurality of fuel injectors in fluid communication with the second combustion zone, the plurality of fuel injectors integrally formed in the liner and arranged around the liner along the circumferential direction.

2. The combustor of claim 1, further comprising a fuel port integrally formed in the liner, the fuel port in fluid communication with the plurality of fuel injectors and extending away from the liner along the radial direction.

3. The combustor of claim 1, further comprising a fuel plenum defined within the liner, the fuel plenum upstream of the plurality of fuel injectors and downstream of the fuel port.

4. The combustor of claim 3, wherein the fuel plenum extends along the circumferential direction between the plurality of fuel injectors.

5. The combustor of claim 3, wherein the fuel plenum extends partially around the liner along the circumferential direction.

6. The combustor of claim 1, wherein the plurality of fuel injectors comprises a first plurality of fuel injectors and the combustor further comprises a second plurality of fuel injectors in fluid communication with the second combustion zone, the second plurality of fuel injectors integrally formed in the liner and arranged around the liner along the circumferential direction.

7. The combustor of claim 6, wherein the first plurality of fuel injectors are in fluid communication with a first fuel plenum and a first fuel port and the second plurality of fuel injectors are in fluid communication with a second fuel plenum and a second fuel port.

8. The combustor of claim 1, wherein the plurality of fuel injectors comprises three fuel injectors equally spaced along a circumferential direction.

9. The combustor of claim 1, wherein the plurality of fuel injectors are slot injectors.

10. A gas turbine, comprising:
a compressor;
a turbine downstream from the compressor; and
a combustor disposed downstream from the compressor and upstream from the turbine, the combustor comprising a central axis, the central axis of the combustor defines an axial direction, a radial direction perpendicular to the central axis, and a circumferential direction extending around the central axis, the combustor comprising:
an annularly shaped liner at least partially defining a hot gas path;
a flow sleeve circumferentially surrounding at least a portion of the liner, wherein the flow sleeve is spaced from the liner along the radial direction to form a cooling flow annulus therebetween;
a first combustion zone at least partially defined by the liner;
a second combustion zone at least partially defined by the liner downstream of the first combustion zone; and
a plurality of fuel injectors in fluid communication with the second combustion zone, the plurality of fuel injectors integrally formed in the liner and arranged around the liner along the circumferential direction.

11. The gas turbine of claim 10, further comprising a fuel port integrally formed in the liner, the fuel port in fluid communication with the plurality of fuel injectors and extending away from the liner along the radial direction.

12. The gas turbine of claim 10, further comprising a fuel plenum defined within the liner, the fuel plenum upstream of the plurality of fuel injectors and downstream of the fuel port.

13. The gas turbine of claim 12, wherein the fuel plenum extends along the circumferential direction between the plurality of fuel injectors.

14. The gas turbine of claim 12, wherein the fuel plenum extends partially around the liner along the circumferential direction.

15. The gas turbine of claim 10, wherein the plurality of fuel injectors comprises a first plurality of fuel injectors and the combustor further comprises a second plurality of fuel injectors in fluid communication with the second combustion zone, the second plurality of fuel injectors integrally formed in the liner and arranged around the liner along the circumferential direction.

16. The gas turbine of claim 15, wherein the first plurality of fuel injectors are in fluid communication with a first fuel plenum and a first fuel port and the second plurality of fuel injectors are in fluid communication with a second fuel plenum and a second fuel port.

17. The gas turbine of claim 10, wherein the plurality of fuel injectors comprises three fuel injectors equally spaced along a circumferential direction.

18. The gas turbine of claim 10, wherein the plurality of fuel injectors are slot injectors.
